(19) United States
(12) Patent Application Publication
(10) Pub. No.: US 2011/0014454 A1
(43) Pub. Date: Jan. 20, 2011

(54) FOAM MOLDING ARTICLE, AND METHOD FOR PRODUCING FOAM MOLDED ARTICLE

(75) Inventors: Yuya Yamamoto, Chiba (JP); Nobuhiro Usui, Chiba (JP); Kenji Atarashi, Chiba (JP); Kenji Watanabe, Chiba (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Chuo-ku, Tokyo (JP)

(21) Appl. No.: 12/933,111

(22) PCT Filed: Mar. 27, 2009
(86) PCT No.: PCT/JP2009/056911

§ 371 Date: Sep. 17, 2010

(30) Foreign Application Priority Data
Mar. 27, 2008 (JP) 2008-083301

(51) Int. Cl. B32B 5/24; B29C 45/17

(52) U.S. Cl. 428/311.51; 264/45.3

(57) ABSTRACT

There are provided a foamed molded article formed of a resin composition comprising a reinforcing fiber and a resin component, wherein the reinforcing fiber comprises a surface-treated fiber (A) comprising a base fiber (A-I) composed of a polyalkylene terephthalate and/or a polyalkylene naphthalene dicarboxylate and from 0.1 to 10 parts by weight, relative to 100 parts by weight of the base fiber (A-I), of a sizing agent (A-II) adhering to the surface of the base fiber (A-1), and the resin component comprises a modified polyolefin resin (B) which is a polyolefin resin modified with an unsaturated carboxylic acid and/or an unsaturated carboxylic acid derivative, wherein the foamed molded article has an expansion ratio of 1.3 to 5, and a method for producing the same.

### TECHNICAL FIELD

The present invention relates to a foamed molded article formed of a resin composition comprising a modified polyolefin resin and a fiber composed of a base fiber composed of a polyalkylene terephthalate and/or a polyalkylene naphthalenedicarboxylate and a sizing agent adhering to the surface of the base fiber.

### BACKGROUND ART

As means for improving the mechanical properties and the heat resistance of a molded article of a thermoplastic resin, incorporation of a reinforcing fiber into a resin to mold has been adopted widely. Moreover, for reducing the weight of thermoplastic resin molded articles, an injection foam molding method using a foaming agent has been adopted. For example, a fiber-reinforced thermoplastic resin lightweight molded article produced from a fiber-containing thermoplastic resin by an injection foaming method using a chemical foaming agent is disclosed in JP 10-119079 A.

However, with regard to conventional fiber-reinforced thermoplastic resin lightweight molded articles produced by an injection foam molding method using a chemical foaming agent predominantly, there was a demand of further improvement in impact resistance.

### DISCLOSURE OF THE INVENTION

The objective of the invention is to provide a foamed molded article with good impact resistance and a method for producing the same.

The present invention relates to a foamed molded article formed of a resin composition comprising a reinforcing fiber and a resin component, wherein the reinforcing fiber comprises a surface-treated fiber (A) comprising a base fiber (A-I) composed of a polyalkylene terephthalate and/or a polyalkylene naphthalene dicarboxylate and from 0.1 to 10 parts by weight, relative to 100 parts by weight of the base fiber (A-I), of a sizing agent (A-II) adhering to the surface of the base fiber (A-1), and the resin component comprises a modified polyolefin resin (B) which is a polyolefin resin modified with an unsaturated carboxylic acid and/or an unsaturated carboxylic acid derivative, wherein the foamed molded article has an expansion ratio is 1.3 to 5.0.

The present invention relates also to a method for producing a foamed molded article, the method comprising the following steps (1) to (6):

(1) a step of melting a resin composition containing a reinforcing fiber and a resin component within a cylinder of an injection molding machine to obtain a molten resin composition, wherein the reinforcing fiber comprises a surface-treated fiber (A) comprising a base fiber (A-I) composed of a polyalkylene terephthalate and/or a polyalkylene naphthalene dicarboxylate and from 0.1 to 10 parts by weight, relative to 100 parts by weight of the base fiber (A-I), of a sizing agent (A-II) adhering to the surface of the base fiber (A-1), and the resin component comprises a modified polyolefin resin (B) which is a polyolefin resin modified with an unsaturated carboxylic acid and/or an unsaturated carboxylic acid derivative,

(2) a step of supplying a physical foaming agent to the cylinder of the injection molding machine and dissolving the physical foaming agent in the molten resin composition to obtain a molten foamable resin composition,

(3) a step of injecting the molten foamable resin composition into a mold cavity formed by a pair of a male mold and a female mold, the volume of the molten foaming resin composition being equal to or smaller than the volume of the cavity,

(4) a step of foaming the fed foamable resin composition within the mold cavity,

(5) a step of cooling and solidifying the foamed resin composition within the mold cavity to provide a foamed molded article,

(6) a step of opening the molds and removing the foamed molded article.

### MODE FOR CARRYING OUT THE INVENTION

The foamed molded article of the present invention is a foamed molded article formed of a resin composition comprising a reinforcing fiber and a resin component, the foamed molded article being characterized mainly in that the reinforcing fiber comprises a surface-treated fiber (A) comprising a base fiber (A-I) composed of a polyalkylene terephthalate and/or a polyalkylene naphthalene dicarboxylate and a sizing agent (A-II) adhering to the surface of the base fiber (A-1), and that the resin component comprises a modified polyolefin resin (B) which is a polyolefin resin modified with an unsaturated carboxylic acid and/or an unsaturated carboxylic acid derivative.

### [Resin Composition]

### <Surface-Treated Fiber (A)>

The surface-treated fiber (A) of the present invention comprises a base fiber (A-I) composed of a polyalkylene terephthalate and/or a polyalkylene naphthalene dicarboxylate and from 0.1 to 10 parts by weight, relative to 100 parts by weight of the base fiber (A-I), of a sizing agent (A-II) adhering to the surface of the base fiber (A-1). (Base fiber (A-I))

The base fiber (A-I) is composed of a polyalkylene terephthalate and/or a polyalkylene naphthalene dicarboxylate. Preferably, the base fiber (A-I) is composed of a polyalkylene naphthalene dicarboxylate.

### (Polyalkylene Naphthalene Dicarboxylate)

A polyalkylene naphthalene dicarboxylate is a polycondensation product of an alkylene diol with a naphthalene dicarboxylic acid, and preferred is a polyester in which alkylene naphthalene dicarboxylate units represented by the following formula (P) or formula (Q) account for 80 mol % or more of the amount of all repeating units. The content of the alkylene naphthalene dicarboxylate units in the polyester is preferably 90 mol % or more of the amount of all repeating units, more preferably 95 mol % or more, and even more preferably from 96 to 100 mol %.

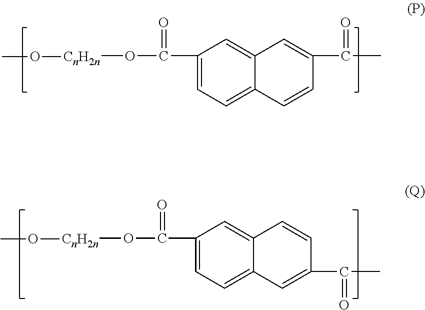

Preferably, the alkylene part contained in the alkylene naphthalene carboxylate is an alkylene part having from 2 to 4 carbon atoms. Examples of the alkylene part include an ethylene part, a trimethylene part, and a tetramethylene part. The polyalkylene naphthalene dicarboxylate is preferably polyethylene naphthalene dicarboxylate, and more preferably polyethylene-2,6-naphthalene dicarboxylate.

### (Polyalkylene Terephthalate)

A polyalkylene terephthalate is a polycondensate of an alkylene diol with terephthalic acid, and preferred is a polyester in which alkylene terephthalate units represented by the following formula (R) account for 80 mol % or more of the amount of all repeating units. The content of the alkylene terephthalate units in the polyester is preferably 90 mol % or more of the amount of all repeating units, more preferably 95 mol % or more, and even more preferably from 96 to 100 mol %.

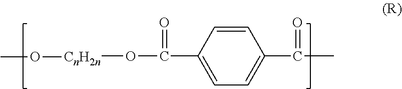

Preferably, the alkylene part contained in the alkylene terephthalate is an alkylene part having from 2 to 4 carbon atoms. Examples of the alkylene part include an ethylene part, a trimethylene part, and a tetramethylene part. Preferably, the polyalkylene terephthalate is polyethylene terephthalate.

The repeating units forming the fiber (A-I) may contain other units (third component) if in a small amount. An example of such a third component is (a) a residue of a compound having two ester-forming functional groups. Examples of a compound which provides such a compound residue having two ester-forming functional groups include aliphatic dicarboxylic acids, such as oxalic acid, succinic acid, sebacic acid, and dimer acid, alicyclic dicarboxylic acids, such as cyclopropane dicarboxylic acid and hexahydro terephthalic acid, aromatic dicarboxylic acids, such as phthalic acid, isophthalic acid, naphthalene-2,7-dicarboxylic acid, and diphenyl carboxylic acid, carboxylic acids, such as diphenyl ether dicarboxylic acid, diphenylsulfonic acid, diphenoxycarboxylic acid, and sodium 3,5-dicarboxybenzenesulfonate, hydroxycarboxylic acids, such as glycolic acid, p-hydroxybenzoic acid, and p-oxyethoxybenzoic acid, and hydroxy compounds, such as propylene glycol, trimethylene glycol, diethylene glycol, tetramethylene glycol, hexamethylene glycol, neopentylene glycol, p-xylene glycol, 1,4-cyclohexanedimethanol, bisphenol A, p,p′-dihydroxyphenylsulfone, 1,4-bis(β-hydroxyethoxy)benzene, 2,2-bis(p-β-hydroxyethoxyphenyl)propane, and polyalkylene glycol. Moreover, their derivatives are also available. Macromolecular compounds made from hydroxycarboxylic acid like those provided above as examples and/or derivatives of hydroxycarboxylic acids like those provided above as examples, and macromolecules made from two or more compounds of at least one compound selected from among carboxylic acids like those provided above as examples and derivatives of carboxylic acids like those provided above as examples, at least one compound selected from among hydroxycarboxylic acids like those provided above as examples and derivatives of hydroxycarboxylic acids like those provided above as examples, and at least one compound selected from among oxy compounds like those provided above as examples and derivatives of oxy compounds like those provided above as examples are provided as examples of the source of the third component.

An example of such a third component is (b) a residue of a compound having one ester-forming functional group. Examples of compounds which provide such a residue of a compound having one ester-forming functional group include benzoic acid, benzyloxybenzoic acid, and methoxypolyalkylene glycol.

(c) A residue of a compound having three or more ester-forming functional groups, such as glycerol, pentaerythritol, and trimethylolpropane, also can be used as a third component source as long as a polymer is substantially linear.

In the polyester which accounts for 80 mol % or more of the amount of all repeating units of the base fiber (A-I) may be contained a delusterant, such as titanium dioxide, and a stabilizer, such as phosphoric acid, phosphorous acid, and their esters.

The base fiber (A-I) as described above has high resistance to a mechanical impact and high affinity for a resin. On the other hand, in a low temperature region where it is practically used, an effect of fiber reinforcement is exerted efficiently.

The single yarn fineness of the base fiber (A-I) is preferably from 1 to 30 dtex and more preferably from 3 to 15 dtex. The upper limit of the single yarn fineness is preferably 20 dtex and more preferably 16 dtex. Preferably, the lower limit of the single yarn fineness is 2 dtex. When the single yarn fineness of the base fiber (A-I) is within such a range, it becomes easy to attain the object of the present invention. When the single yarn fineness is less than 1 dtex, a problem with respect to spinnability tends to occur, and when the fineness is excessively high, the interfacial strength between fiber and resin tends to lower. From the viewpoint of dispersion of fiber, the fineness is preferably 1 dtex or more, and from the viewpoint of reinforcing effect, the fineness is preferably 30 dtex or less.

The intrinsic viscosity of the material of the base fiber (A-I) is preferably 0.7 dl/g or more, and more preferably from 0.7 to 1.0 dl/g. The intrinsic viscosity is a value determined from a viscosity measured at 35° C. following dissolution of the fiber in a mixed solvent of phenol and orthodichlorobenzene (volume ratio 6:4). When the intrinsic viscosity is less than 0.7 dl/g, the strength and toughness of the fiber tend to be low and the heat resistance tends to be low. On the other hand, a material whose intrinsic viscosity exceeds 1.0 dl/g has a tendency that the production of fiber is difficult.

The tensile strength of the base fiber (A-I) is preferably from 6 to 11 cN/dtex and more preferably from 7 to 10 cN/dtex. When it is less than 6 cN/dtex, the tensile strength of a resin composition tends to become low. The tensile modulus of the base fiber (A-1) is preferably from 18 to 30 GPa and more preferably from 20 to 28 GPa. There is a tendency that the flexural strength of a resin composition lowers as this value becomes small.

The dry heat shrinkage at 180° C. of the base fiber (A-I) is preferably 8% or less and more preferably 7% or less. When the dry heat shrinkage exceeds 8%, there is a tendency that the dimensional change of the fiber caused by heat applied at the time of molding becomes large, so that deficiencies occur in molded shape of the resin composition, and there is another tendency that gaps are formed between the resin and the fiber, so that reinforcing effect decreases.

The base fiber (A-I) having such strength can be produced by a conventional method. Specifically, the base fiber (A) can be obtained by subjecting chips of a polyalkylene terephthalate and/or a polyalkylene naphthalene dicarboxylate prepared by polymerization further to solid phase polymerization or the like to fully increase their intrinsic viscosity, melt-spinning the chips, and then drawing. Preferably, the spinning is carried out in the form of multifilament, and it is desirable that the total fineness of the multifilament be within the range of from 500 to 50,000 dtex and the number of filaments be within the range of from 25 to 25,000 filaments.

The drawing can be carried out by winding an undrawn yarn once after the spinning and then drawing the undrawn yarn. It is also permissible to draw an undrawn yarn continuously without winding. The fiber produced by drawing is a fiber which is high in modulus and also excels in dimensional stability.

### <Sizing Agent (A-II)>

In the surface-treated fiber (A), the sizing agent (A-II) is adhering on the surface of the base fiber (A-I) in an amount of from 0.1 to 10 parts by weight, preferably from 0.1 to 3 parts by weight, relative to 100 parts by weight of the base fiber (A-I). Examples of the sizing agent (A-II) include polyolefin resins, polyurethane resins, polyester resins, acrylic resins, epoxy resins, starch, vegetable oils, and mixtures of these with epoxy compounds. Preferably, the sizing agent (A-II) contains at least one resin selected from the group consisting of polyolefin resins and polyurethane resins.

### (Polyolefin Resin)

Preferred as the polyolefin resin of the sizing agent (A-II) is a resin selected from the group consisting of homopolymers of olefins and copolymers of two or more olefins. Specific examples of the polyolefin resin include polyethylene, polypropylene, polymethylpentene, ethylene-propylene random copolymers, ethylene-propylene block copolymers, ethylene-α-olefin copolymers, and propylene-α-olefin copolymers. Preferred as the polyolefin resin are polyethylene resins and polypropylene resins. Preferred as the polyolefin resins are acid-modified polyolefin resins obtained by modifying the aforementioned polyolefin resins with acid components.

An example of the acid-modified polyolefin resins is a sulfonated polyolefin resin. The sulfonated polyolefin resin can be produced by chlorosulfonating an unmodified polyolefin resin by the use of chlorine and sulfur dioxide or a chlorosulfonic acid, and then converting the introduced chlorosulfone group into a sulfone group. The sulfonated polyolefin resin can be produced by sulfonating an unmodified polyolefin resin directly. Particularly, a sulfonated polyethylene and a sulfonated polypropylene are preferred.

Examples of the acid-modified polyolefin resins include resins obtained by modifying unmodified polyolefin resins with an unsaturated carboxylic acid and/or an unsaturated carboxylic acid derivative. In the following description, such modified resins may be referred collectively to as “unsaturated carboxylic acid-modified polyolefin resins.” Examples of the unsaturated carboxylic acid to be used for modification include maleic acid, fumaric acid, itaconic acid, acrylic acid, and methacrylic acid. The derivatives of unsaturated carboxylic acids include anhydrides, esters, amides, imides, and metal salts of these acids. Specific examples of the unsaturated carboxylic acid derivatives include maleic anhydride, itaconic anhydride, methyl acrylate, ethyl acrylate, butyl acrylate, glycidyl acrylate, methyl methacrylate, ethyl methacrylate, glycidyl methacrylate, monoethyl maleate, diethyl maleate, monomethyl fumarate, dimethyl fumarate, acrylamide, methacrylamide, maleic monoamide, maleic diamide, fumaric monoamide, maleimide, N-butylmaleimide, and sodium methacrylate. When modification is carried out by using a derivative having no free carboxylic acid group, a carboxylic acid group is generated by hydrolysis or the like after the modification. Most preferred for the present invention among unsaturated carboxylic acid compounds and their derivatives are glycidyl esters of acrylic acid and methacrylic acid and maleic anhydride.

An unsaturated carboxylic acid-modified polyolefin resin can also be produced by copolymerizing a polymerizable unsaturated carboxylic acid or its derivative to an olefin during the production of an olefin resin. Specifically, it can be produced by random copolymerizing or block copolymerizing at least one olefin monomer with at least one unsaturated carboxylic acids and/or at least one unsaturated carboxylic acid derivative. It is also permissible to further graft-polymerizing an unsaturated carboxylic acid and/or an unsaturated carboxylic acid derivative to a resulting modified polyolefin resin. Especially preferred is a product having been acid-modified by copolymerization of olefin monomers comprising ethylene and/or propylene as primary ingredients with a (meth)acrylic acid glycidyl ester or maleic anhydride.

The unsaturated carboxylic acid modified polyolefin resin can be produced also by graft polymerizing an unsaturated carboxylic acid compound and/or a derivative of an unsaturated carboxylic acid to a homopolymer of an olefin or a copolymer of two or more kinds of olefins. Especially preferred is a modified polyolefin resin obtained by graft polymerizing maleic anhydride to an unmodified polyolefin resin comprising ethylene and/or propylene as primary constitutional units. By the use of a sizing agent comprising such a modified polyolefin resin, it is possible to obtain high adhesiveness between a base fiber and a resin component. Moreover, a modified polyolefin resin having a weight average molecular weight of from 1,000 to 10,000 is preferred because it is high in adhesiveness to fibers. The weight of the unsaturated carboxylic acid component to be graft-polymerized to an unmodified polyolefin resin, such as maleic anhydride, is preferably from 0.01 to 20% by weight relative to the unmodified polyolefin resin. The weight average molecular weight of the modified polyolefin resin is preferably 500 or more, more preferably from 1,000 or more, and even more preferably from 2,000 to 150,000. When the weight average molecular weight is less than 500, the strength of a coating resin film to be formed on the fiber is low, so that there is a tendency that satisfactory compatibility or adhesion performance of the fiber to the resin to be reinforced is difficult to be obtained.

The softening temperature of the polyolefin resin contained in the sizing agent (A-II) is preferably from 80 to 160° C., more preferably from 90 to150° C., and even more preferably from 100 to 140° C. When the softening temperature is lower than 80° C., the resin easily falls off during a drying stage in the dipping step in the production of the surface-treated fiber (A) and, in some cases, the fallen resin adheres to rollers, guides or the like of the dipping equipment, so that the step passing efficiency is lowered. When the softening temperature exceeds 160° C., the resin is difficult to soften in the heat treatment step in the dipping step and, as a result, the resin becomes difficult to spread to between single yarns of the fiber. If the polyolefin resin has an appropriate softening temperature, the resin is molten in the heat treatment in the dipping step to spread to between single yarns of the fiber and the polyolefin resin can exert a function to bundle the fiber when it is cooled.

The adhering amount of the sizing agent (A-II) is preferably from 0.1 to 10 parts by weight, preferably from 0.2 to 10 parts by weight, and even more preferably from 0.3 to 3 parts by weight relative to 100 parts by weight of the fiber (A-I). When the adhering amount of the sizing agent (A-II) is less than 0.1 parts by weight relative to 100 parts by weight of the fiber, the effect of reinforcing resin tends to be insufficient. On the other hand, when the adhering amount of the sizing agent (A-II) is excessively large, there is a tendency that single yarns forming the base fiber are fixed together by the sizing agent (A-II), so that the surface-treated fiber becomes hard and there also is a tendency that the lubricity of the surface-treated fiber deteriorates remarkably, so that the breakage of single yarns occurs in the production of a resin composition and the impregnation efficiency of the resin component becomes insufficient.

Preferably, the sizing agent (A-II) comprises at least one polyolefin resin and at least one epoxy compound having two or more epoxy groups in one molecule. Particulars of the polyolefin resin are as described previously. Examples of the epoxy compound include glycidyl ether compounds, such as glycerol polyglycidyl ether, diglycerol polyglycidyl ether, polyglycerol polyglycidyl ether, and sorbitol polyglycerol glycidyl ether. Especially, glycidyl ether compounds are preferred and the use of a sizing agent containing a glycidyl ether compound can result in increase in the adhesive force between the surface-treated fiber (A) and a resin component.

The amount of the epoxy compound is preferably from 0.1 to 1 part by weight, more preferably from 0.2 to 0.8 parts by weight, relative to 100 parts by weight of the base fiber (A-I). When the amount of the epoxy compound is less than 0.1 parts by weight, the reinforcing effect of the surface-treated fiber tends to be insufficient. On the other hand, when the amount of the epoxy compound exceeds 1 part by weight, there is a tendency that the lubricity of the surface-treated fiber deteriorates remarkably, so that the breakage of single yarns occurs in the production of a resin composition and the impregnation efficiency of the resin component becomes insufficient. Single yarns forming the base fiber are fixed together, so that they become difficult to disperse in the resin component to be reinforced. Therefore, the content of the epoxy compound in the sizing agent (A-II) is preferably from 1 to 50 parts by weight, more preferably from 5 to 30 parts by weight, relative to 100 parts by weight of the polyolefin resin. Preferably, the surface-treated fiber (A) comprises 100 parts by weight of the fiber (A-I), from 0.1 to 2 parts by weight of a polyolefin resin modified with an unsaturated carboxylic acid and/or an unsaturated carboxylic acid derivative, and from 0.1 to 1 part by weight of an epoxy compound having two or more epoxy groups in one molecule.

Preferably, the sizing agent (A-II) contains at least one polyolefin resin and an ethylene oxide adduct of an aliphatic amine compound and/or a propylene oxide adduct of an aliphatic amine compound. Moreover, it is desirable that the sizing agent (A-II) contain one epoxy compound. Such a sizing agent increases the adhesiveness to a resin component. Particulars of the polyolefin resin and the epoxy compound are as previously described.

The aliphatic amine compound preferably is an aliphatic amine compound having from 4 to 22 carbon atoms and more preferably is an alkylamine compound having from 4 to 22 carbon atoms. Examples of an alkyl group include a butyl group, a lauryl group, a stearyl group, and an oleyl group. In an ethylene oxide adduct of an aliphatic amine compound or a propylene oxide adduct of an aliphatic amine compound, the added number of ethylene oxide or propylene oxide is preferably from 2 to 20 mol relative to 1 mol of the aliphatic amine compound. Specific examples of such an ethylene oxide adduct of an aliphatic amine compound and a propylene oxide adduct of an aliphatic amine compound include POE (4-20) laurylamino ether, POE (20) stearylamino ether, POE (2-20) oleylamino ether, EO (5)/PO (4) monobutylamino ether, POE (2-20) laurylethanolamine, and POE (2-20) lauryldiethanolamine. POE means polyoxyethylene, EO means ethylene oxide, and PO means propylene oxide. The numbers in the parentheses represent the added molar numbers of ethylene oxide and propylene oxide per mol of an aliphatic amine compound. In the present invention, it becomes possible to attain a high effect of reinforcing a resin component by a surface-treated fiber by the use of a sizing agent containing an ethylene oxide adduct of an aliphatic amine compound and/or a propylene oxide adduct of an aliphatic amine compound.

The amount of the ethylene oxide adduct of an aliphatic amine compound and/or the propylene oxide adduct of an aliphatic amine compound is preferably from 0.01 to 0.3 parts by weight, more preferably from 0.03 to 0.2 parts by weight, relative to 100 parts by weight of the base fiber (A-I). When the amount of such agents is less than 0.01 parts by weight relative to 100 parts by weight of the fiber, the effect of reinforcing the resin component tends to be insufficient. On the other hand, when the amount of such agents exceeds 0.3 parts by weight, there is a tendency that the lubricity of the surface-treated fiber deteriorates remarkably, so that the breakage of single yarns occurs in the production of a resin composition and the impregnation efficiency of the resin component becomes insufficient. Therefore, the content of the ethylene oxide adduct of an aliphatic amine compound and/or the propylene oxide adduct of an aliphatic amine compound in the sizing agent (A-II) is preferably from 0.5 to 30 parts by weight, more preferably from 1 to 20 parts by weight, relative to 100 parts by weight of the polyolefin resin.

### (Polyurethane Resin)

As the sizing agent (A-II) may be used a polyurethane resin. The polyurethane resin to be used in the present invention can be obtained by addition-polymerizing a compound having two hydroxyl groups in the molecule (this is hereinafter referred to as diol component) with a compound having two isocyanate groups in the molecule (this is hereinafter referred to as diisocyanate component) in an organic solvent containing no water and having no active hydrogen. It is also possible to obtain a desired polyurethane resin by making raw materials react directly in the absence of solvent. Examples of the diol component include polyol compounds, such as polyester diol, polyether diol, polycarbonate diol, polyetherester diol, polythioether diol, polyacetal, and polysiloxane; and low molecular weight glycols, such as an ethylene glycol, 1,4-butanediol, 1,6-hexandiol, 3-methyl-1,5-pentanediol, and diethylene glycol. Preferably, the polyurethane resin to be used for the present invention is rich in a low molecular weight glycol component.

As the diisocyanate component is used an aromatic diisocyanate or an aliphatic diisocyanate. Specifically, diisocyanate components which can be used include tolylene diisocyanate, xylylene diisocyanate, naphthalene diisocyanate, diphenylmethane diisocyanate, hexamethylene diisocyanate, cyclohexyldiisocyanate, dicyclohexylmethane diisocyanate, and isophorone diisocyanate. Preferably, the polyurethane resin to be used for the present invention is rich in aromatic diisocyanate components.

Since it is desirable that the polyurethane resin reach the surface of single yarns of the base fiber, it is preferable to apply the polyurethane resin to the base fiber by a dipping process. Therefore, it is desirable that the polyurethane resin be in the form of an aqueous emulsion or suspension, and for reaching the surface of single yarns of the base fiber, it is desirable that the dispersed particle diameter of the polyurethane resin in the emulsion or suspension be as small as possible. Specifically, the dispersed particle diameter is preferably 0.2 μm or less, more preferably 0.15 μm or less, and even more preferably 0.1 μm or less. When the dispersed particle diameter is 0.2 μm or more, polyurethane particles fail to reach single yarns inside the base fiber by the dipping treatment and there is a fear that the polyurethane resins can be applied only to single yarns located in the surface of the base fiber.

There is no particular limitation with the method of dispersing the polyurethane resin in the form of emulsion or suspension into water. It is permissible to use either of a method of obtaining an emulsion by allowing a polyurethane resin to self-emulsify by using hydrophilic groups in the polyurethane resin and a method of obtaining a suspension by dispersing a polyurethane resin that cannot self-emulsify by the use of a dispersing agent such as a surfactant or the like. An emulsion is easier to perform preparation and stabilization of fine particles dispersed in water, and an emulsion is more advantageous also in facility aspect. Preferably, the polyurethane resin to be used for the present invention is self-emulsifiable one because dispersing agents, such as surfactants, that are necessary for the preparation of a suspension are highly probable to become impurities when preparing a resin composition in the following steps and may deteriorate the properties of a product.

Although there is no particular restriction on the method of introducing hydrophilic groups to the polyurethane resin, a polyurethane resin having hydrophilic groups can be obtained, for example, by adding a diol component having an anionic group such as carboxylate and sulfonate or a cation group such as a quaternary amine and/or a diisocyanate component having an anionic group such as carboxylate and sulfonate or a cation group such as a quaternary amine to a diol component and a diisocyanate component which are to be subjected to addition polymerization, and then copolymerizing them.

Although it is desirable that a polyurethane resin to be used for the present invention has adhered uniformly to the surface of each single yarn of a base fiber, which is a multifilament, to bundle the single yarns, it is necessary for the polyurethane resin to dissociate single yarns at a low share in a step of kneading with the polyolefin resin and work to disperse the single yarns in the polyolefin resin. For meeting this requirement, a dry coating film of the polyurethane resin is needed to be an elastic body with a low degree of elongation and it is undesirable that the dry coating film be soft and sticky. Therefore, the tensile strength of a dry coating film of the polyurethane resin is preferably from 10 to 60 Mpa, and more preferably from 20 to 50 Mpa. When the tensile strength of a dry coating film of the resin is less than 10 Mpa, the film of the resin breaks easily and cannot impart a bundling property to a surface-treated fiber (A). When the tensile strength of a dry coating film of the resin exceeds 60 Mpa, single yarns become difficult to dissociate in a kneading step and uneven dispersion of the surface-treated fiber (A) becomes easy to occur.

The degree of elongation of the dry coating film of the polyurethane resin is preferably from 1 to 50%, more preferably from 5 to 45%, and even more preferably from 10 to 40%. When a dry coating film of the resin has a degree of elongation of less than 1%, the film of the resin breaks easily and cannot impart a bundle-forming property to a fiber. On the contrary, when it exceeds 50%, single yarns become difficult to dissociate in a kneading step and uneven dispersion of the surface-treated fiber (A) becomes easy to occur.

The method for producing dry coating films of polyurethane resins to be used for the measurement of tensile strength or degree of elongation is as follows. It is possible to obtain a good dry coating film by removing volatile components by a casting method using a glass petri dish, a Teflon petri dish, or the like at a treatment temperature of from room temperature to about 120° C. for a treatment time appropriately adjusted according to the sample. The film thickness is preferably from 0.1 to 1.0 mm, and more preferably from 0.5 to 1.0 mm. The film is processed in conformity to measurement. For example, in measuring a tensile strength and a degree of elongation, a specimen was punched into a dumbbell-like form and it was used as a specimen for a tensile test.

The glass transition temperature of a dry coating film of the polyurethane resin is preferably from 30 to 100° C., more preferably from 40 to 90° C., and even more preferably from 50 to 80° C. When the glass transition temperature of a dry coating film of the resin is lower than 30° C., the coating film of the resin becomes viscous, so that single yarns becomes difficult to dissociate in the kneading step and, as a result, uneven dispersion of fibers becomes easy to occur. When the glass transition temperature of a dry coating film of the resin exceeds 100° C., the coating resin film becomes so hard and tough that single yarns become difficult to dissociate in a kneading step. Preferably, the polyurethane resin has a glass transition temperature of 30° C. or higher, preferably 50° C. or higher and its dry coating film is low in degree of elongation. In such a case, a bundling property is imparted to the surface-treated fiber (A) during steps before mixing the surface-treated fiber to a resin component, and in the step of impregnating a surface-treated fiber bundle with the resin component a multifilament can be easily dissociated into single yarns by shear applied in the step, so that a resin composition with higher performance is produced.

The softening temperature of the polyurethane resin is preferably from 80 to 160° C., more preferably from 90 to 150° C., and even more preferably from 100 to 140° C. When the softening temperature is lower than 80° C., the resin easily falls off during a drying stage in the dipping step in the production of the surface-treated fiber (A) and, the fallen resin adheres to rollers, guides or the like of the dipping equipment, so that the step passing efficiency is lowered. When the softening temperature exceeds 160° C., the resin is difficult to soften in the heat treatment step in the dipping step and, as a result, the resin becomes difficult to spread to between single yarns of the fiber. If the polyurethane resin has an appropriate softening temperature, the resin is softened in the heat treatment in the dipping step to spread to between single yarns of the fiber and the polyurethane resin can exert a function to bundle the fiber when it is cooled.

### (Surface Treating Agent)

To the sizing agent (A-II) may be incorporated a surface treating agent in order to improve the wettability, the adhesiveness or the like with a resin component. Examples of the surface treating agent include silane coupling agents, titanate coupling agents, aluminum coupling agents, chromium coupling agents, zirconium coupling agents, and borane coupling agents. Silane coupling agents or titanate coupling agents are preferred, and silane coupling agents are more preferred.

Examples of silane coupling agents include triethoxysilane, vinyltris(β-methoxyethoxy)silane, γ-methacryloxypropyltrimethoxysilane, γ-glycidoxypropyltrimetoxysilane, β-(3,4-epoxycyclohexyl)ethyltrimethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, γ-mercaptopropyltrimethoxysilane, and γ-chloropropyltrimetoxysilane, and preferred are aminosilanes, such as γ-aminopropyltriethoxysilane and N-β-(aminoethyl)-γ-aminopropyltrimethoxysilane.

The content of the surface-treating agent in the sizing agent (A-II) is preferably from 0.01 to 10% by weight and more preferably from 0.02 to 5% by weight.

Other treating agents, e.g., smoothers such as mineral oils and fatty acid esters, emulsifiers such as higher alcohol ethylene oxide adducts and cured castor oil ethylene oxide adducts, antistatic agents, heat resisting agents, colorants, and the like may be used as far as the effect of the present invention is not impaired.

### (Surface Treatment)

The surface-treated fiber (A) is a material obtained by making the sizing agent (A-II) adhere to the surface of the base fiber (A-I). Preferably, the adhesion treatment is performed by impregnating a fiber bundle with a treating solution containing a sizing agent and then drying the fiber bundle containing the treating solution by heat within a drier. From the viewpoints of retention of the strength of the surface-treated fiber (A) and the adhesion of the treatment agent, it is optimal that the drying temperature be from 80 to 200° C. and the drying time be about from 30 to about 300 seconds. At this time, it is preferred that the drier be of a noncontact type so that the surface condition of fibers can be maintained.

### <Modified Polyolefin Resin (B)>

The resin composition that forms the foamed molded article of the present invention comprises a modified polyolefin resin (B) as a resin component. The modified polyolefin resin (B) is a resin obtained by modifying a polyolefin resin with an unsaturated carboxylic acid and/or an unsaturated carboxylic acid derivative. Here, the polyolefin resin to be used as a raw material of the modified polyolefin resin (B) is a resin composed of a homopolymer of an olefin or a copolymer of two or more olefins. The modified polyolefin resin (B) is, in other words, a resin that is obtained by making at least one compound selected from the group consisting of unsaturated carboxylic acids and unsaturated carboxylic acid derivatives react with a homopolymer of an olefin or a copolymer of two or more olefins and that has a partial structure derived from an unsaturated carboxylic acid or an unsaturated carboxylic acid derivative in the molecule. Examples of the modified polyolefin resin (B) include the following modified polyolefin resins (B-a), (B-b), and (B-c). As the modified polyolefin resin (B) can be used one or more member selected from among the modified polyolefin resins (B-a), (B-b), and (B-c) listed below.

(B-a) A modified polyolefin resin obtained by graft polymerizing an unsaturated carboxylic acid and/or an unsaturated carboxylic acid derivative to a homopolymer of an olefin.

(B-b) A modified polyolefin resin obtained by graft polymerizing an unsaturated carboxylic acid and/or an unsaturated carboxylic acid derivative to a copolymer obtained by copolymerizing two or more olefins.

(B-c) A modified polyolefin resin obtained by graft polymerizing an unsaturated carboxylic acid and/or an unsaturated carboxylic acid derivative to a block copolymer obtained by homopolymerizing an olefin and then copolymerizing two or more olefins.

The modified polyolefin resin (B) can be produced by a solution process, a bulk process, a melt kneading process, and so on. Two or more processes may be used in combination. Specific examples of the solution process, the bulk process, the melt kneading process, and so on include the methods disclosed in “Practical Design of Polymer Alloy” Fumio IDE, Kogyo Chosakai Publishing Co. (1996), Prog. Polym. Sci., 24, 81-142 (1999) and JP 2002-308947 A, JP 2004-292581 A, JP 2004-217753 A, JP 2004-217754 A, and so on.

As the modified polyolefin resin (B) may be used modified polyolefin resins placed on the market, and examples thereof include commercial name: MODIPER (produced by NOF Corp.), commercial name: BLENMER CP (produced by NOF Corp.), commercial name: BONDFAST (produced by Sumitomo Chemical Co., Ltd.), commercial name: BONDINE (produced by Sumitomo Chemical Co., Ltd.), commercial name: REXPERL (produced by Japan Polyethylene Corp.), commercial name: ADMER (produced by Mitsui Chemicals, Inc.) commercial name: MODIC AP (produced by Mitsubishi Chemical Corp.), commercial name: POLYBOND (produced by Crompton Corp.), and commercial name: YOUMEX (produced by Sanyo Chemical Industries, Ltd.)

Examples of the unsaturated carboxylic acid to be used for the production of the modified polyolefin resin (B) include unsaturated carboxylic acids having three or more carbon atoms, such as maleic acid, fumaric acid, itaconic acid, acrylic acid, and methacrylic acid. The unsaturated carboxylic acid derivatives include anhydrides, ester compounds, amide compounds, imide compounds, and metal salts of unsaturated carboxylic acids. Specific examples of the unsaturated carboxylic acid derivatives include maleic anhydride, itaconic anhydride, methyl acrylate, ethyl acrylate, butyl acrylate, glycidyl acrylate, methyl methacrylate, ethyl methacrylate, butyl methacrylate, glycidyl methacrylate, 2-hydroxyethyl methacrylate, monoethyl maleate, diethyl maleate, monomethyl fumarate, dimethyl fumarate, acrylamide, methacrylamide, maleic acid monoamide, maleic acid diamide, fumaric acid monoamide, maleimide, N-butylmaleimid, and sodium methacrylate. For the modification of a polyolefin with an unsaturated carboxylic acid, a compound that dehydrates to generate an unsaturated carboxylic acid during the step of grafting to the polyolefin, like citric acid or malic acid, can be used as a source of the unsaturated carboxylic acid. The unsaturated carboxylic acid and the unsaturated carboxylic acid derivative preferably include acrylic acid, glycidyl methacrylate, maleic anhydride, and 2-hydroxyethyl methacrylate.

Preferred as the modified polyolefin resin (B) is the following resin (B-d).

(B-d) A resin obtained by graft polymerizing maleic anhydride, glycidyl methacrylate or 2-hydroxyethyl methacrylate to a polyolefin resin containing units derived from at least one olefin selected from among ethylene and propylene as main constitutional units.

From the viewpoint of mechanical strength such as impact strength, fatigue characteristics, and rigidity, the content of the constitutional units derived from an unsaturated carboxylic acid and/or an unsaturated carboxylic acid derivative of the modified polyolefin resin (B) is preferably from 0.1 to 10% by weight, more preferably from 0.1 to 5% by weight, even more preferably from 0.2 to 2% by weight, and particularly preferably from 0.4 to 1% by weight. The content of the constitutional units derived from an unsaturated carboxylic acid and/or an unsaturated carboxylic acid derivative is a value calculated after quantifying the absorption based on the unsaturated carboxylic acid and/or the unsaturated carboxylic acid derivative by an infrared absorption spectrum or an NMR spectrum.

### <Polyolefin Resin (C)>

The resin component of a resin composition may further comprise a polyolefin resin (C). The polyolefin resin (C) is a resin that is composed of a homopolymer of an olefin or a copolymer of two or more olefins. Modified polyolefin resins, for example, polyolefin resins having been modified with an unsaturated carboxylic acid or an unsaturated carboxylic acid derivative do not correspond to the polyolefin resin (C). Examples of the polyolefin resin (C) include a polypropylene resin and a polyethylene resin. Preferred as the polyolefin resin (C) is a polypropylene resin. The polyolefin resin (C) may be either a single polyolefin resin or a mixture of two or more polyolefin resins.

Examples of the polypropylene resin include propylene hompolymers, propylene-ethylene random copolymers, propylene-cc-olefin random copolymers, propylene-ethylene-α-olefin random copolymers, and propylene-based block copolymers obtained by homopolymerizing propylene to form a propylene homopolymer and then copolymerizing ethylene with propylene in the presence of the propylene homopolymer. Preferred as the polypropylene resin from the viewpoint of heat resistance are propylene homopolymers and propylene-based block copolymers produced by homopolymerizing propylene and then copolymerizing ethylene with propylene.

All the content of the constitutional units derived from ethylene of a propylene-ethylene random copolymer wherein the total amount of propylene and ethylene is 100 mol %, the content of the constitutional units derived from α-olefin of a propylene-α-olefin random copolymer wherein the total amount of propylene and α-olefin is 100 mol %, the total content of the constitutional units derived from ethylene and α-olefin of a propylene-ethylene-α-olefin random copolymer wherein the total amount of propylene, ethylene and α-olefin is 100 mol % are less than 50 mol %. The aforementioned content of ethylene, the content of α-olefin, and the total content of ethylene and α-olefin are determined by the IR method or the NMR method disclosed in “New Edition Macromolecule Analysis Handbook” (The Japan Society for Analytical Chemistry, edited by Polymer Analysis Division, Kinokuniya Co., Ltd. (1995)).

Examples of the polyethylene resin include ethylene homopolymers, ethylene-propylene random copolymers, and ethylene-α-olefin random copolymers. All the content of the constitutional units derived from propylene of an ethylene-propylene random copolymer wherein the total amount of ethylene and propylene is 100 mol %, the content of the α-olefin contained in an ethylene-cc-olefin random copolymer wherein the total amount of ethylene and cc-olefin is 100 mol %, and the total content of the propylene and the α-olefin contained in an ethylene-propylene-α-olefin random copolymer wherein the total amount of ethylene, propylene, and the α-olefin is 100 mol % are less than 50 mol %.

Examples of the α-olefin that is a constituent of the polyolefin resin (C) include 1-butene, 2-methyl-1-propene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene and 1-dodecene. Preferred are α-olefins having from 4 to 8 carbon atoms (e.g., 1-butene, 1-pentene, 1-hexene, and 1-octene).

The polyolefin resin (C) can be produced by a solution polymerization method, a slurry polymerization method, a bulk polymerization method, a gas phase polymerization method, etc. Such polymerization methods may be used singly and two or more polymerization methods may be combined. Examples of a more specific production method of the polyolefin resin (C) include the polymerization methods disclosed in “New Polymer Production Process” edited by Yasuji SAEKI, published by Kogyo Chosakai Publishing Co. (1994), JP 4-323207A, JP 61-287917A and so on.

Examples of the catalyst to be used for the production of the polyolefin resin (C) include multisite catalysts and single-site catalysts. Examples of preferable multisite catalysts include catalysts obtained by using a solid catalyst component comprising a titanium atom, a magnesium atom, and a halogen atom, and preferable single-site catalysts include metallocene catalysts. An example of preferable catalysts to be used for the production of a polypropylene resin as the polyolefin resin (C) is a catalyst obtained by using the aforementioned solid catalyst component comprising a titanium atom, a magnesium atom, and a halogen atom.

From the viewpoints of the dispersibility of the surface-treated fiber (A) in a molded article, the deficiency in the appearance and the impact strength of a molded article, the melt flow rate (MFR) of the polyolefin resin (C) is preferably from 1 to 500 g/10 minutes, more preferably from 10 to 400 g/10 minutes, and even more preferably from 20 to 300 g/10 minutes. The MFR is a value measured at a temperature of 230° C. and a load of 21.2 N according to ASTM D1238.

The isotactic pentad fraction of a propylene homopolymer as the polyolefin resin (C) is preferably from 0.95 to 1.0, more preferably from 0.96 to 1.0, and even more preferably from 0.97 to 1.0. The isotactic pentad fraction is a fraction of units derived from propylene monomers which are each present at the center of an isotactic chain in the form of a pentad unit, namely a chain in which five propylene monomer units are meso-bonded successively, in the propylene molecular chain, as measured by the method reported in A. Zambelli et al., Macromolecules, 6, 925 (1973), namely, by a method using ¹³C-NMR. NMR absorption peaks are assigned according to Macromolecules, 8, 687 (1975).

When the polyolefin resin (C) is a propylene block copolymer obtained by homopolymerizing propylene and then copolymerizing ethylene with propylene, the isotactic pentad fraction of the above-mentioned propylene homopolymer portion is preferably from 0.95 to 1.0, more preferably from 0.96 to 1.0, and even more preferably from 0.97 to 1.0.

The resin composition to form the foamed molded article of the present invention comprises a modified polyolefin resin (B), which is a polyolefin resin having been modified with an unsaturated carboxylic acid and/or an unsaturated carboxylic acid derivative, as a resin component. In comparison of cases that are equal in the content of the constitutional units derived from an unsaturated carboxylic acid and/or the an unsaturated carboxylic acid derivative in the resin component of the above-mentioned resin composition, from the viewpoint of the mechanical strength of the whole resin composition, that the resin composition comprise a large amount of an unmodified polyolefin resin (C) and a small amount of a highly modified polyolefin resin (B) in combination is preferred than that the resin composition contains, as a resin component, only a modified polyolefin resin (B) that is low in degree of modification with an unsaturated carboxylic acid and/or an unsaturated carboxylic acid derivative. With regard to the modified polyolefin resin (B), when modification is done with an unsaturated carboxylic acid and/or an unsaturated carboxylic acid derivative, the polymer in the resulting modified resin tends to have a molecular weight smaller than the molecular weight of the polymer in the polyolefin resin before the modification. Therefore, preferred in the present invention is an embodiment in which the resin composition to be subjected to injection molding comprises a modified polyolefin resin (B) and a polyolefin resin (C) as resin components.

When the resin component of the resin composition that forms the foamed molded article of the present invention contains a polyolefin resin (C), the content of the modified polyolefin resin (B) and the content of the polyolefin resin (C) in the resin component are preferably from 0.5 to 40% by weight and from 60 to 99.5% by weight, more preferably from 0.5 to 30% by weight and from 70 to 99.5% by weight, and even more preferably from 1 to 20% by weight and from 80 to 99% by weight, respectively, from the viewpoints of the rigidity and the mechanical strength of a resin component and the viewpoint of the impregnation efficiency of the resin component to the fiber bundle of the resin composition.

When the resin composition to form the foamed molded article of the present invention contains the polyolefin resin (C), the content of the surface-treated fiber (A) and the content of the resin component in the resin composition are preferably from 1 to 70% by weight and from 30 to 99% by weight, more preferably from 5 to 68% by weight and from 32 to 95% by weight, even more preferably from 10 to 65% by weight and from 35 to 90% by weight, particularly preferably from 15 to 60% by weight and from 40 to 85% by weight, and most preferably from 20 to 55% by weight and from 45 to 80% by weight, respectively, from the viewpoints of the rigidity and mechanical strength of the resin composition and the viewpoint of the appearance of the molded article of the resin composition.

In the resin component of the resin composition to form the foamed molded article of the present invention may be incorporated one or more elastomers. Examples of the elastomers include polyester-based elastomers, polyurethane-based elastomers, and PVC-based elastomer.

In the resin composition to form the foamed molded article of the present invention may be incorporated stabilizers such as antioxidants, heat stabilizers, neutralizers and UV absorbers, foam inhibitors, flame retardants, flame retardant aids, dispersing agents, antistatic agents, lubricants, antiblocking agents such as silica, colorant such as dyes and pigments, plasticizers, nucleating agents, and crystallization accelerators.

Tabular, powdery, or whisker-like inorganic compounds, such as glass flake, mica, glass powder, glass beads, talc, clay, alumina, carbon black and wollastonite, may also be incorporated.

### <Method for Producing a Resin Composition>

Examples of the method for producing the resin composition to form the foamed molded article of the present invention include the following methods (1) to (3).

(1) A method that comprises mixing all components to form a mixture and then melt-kneading the mixture.

(2) A method that comprises obtaining a mixture by sequentially adding all components and then melt-kneading the mixture.

(3) A pultrusion method.

In the method (1) or (2) provided above, the method of obtaining a mixture to melt-knead may be, for example, a method in which mixing is performed by using a Henschel mixer, a ribbon blender, a blender, or the like. The method of melt-kneading may be a method in which melt-kneading is performed by using a Banbury mixer, a plastomill, a Brabender plastograph, a single or twin screw extruder, or the like.

The resin composition to form the foamed molded article of the present invention can be produced by the pultrusion method. The pultrusion method is preferred from the viewpoints of the easiness of the production of a resin composition, the rigidity, the mechanical strength such as impact strength and the vibration-damping property of a molded article to be obtained. The pultrusion method is basically a method in which while pulling a continuous fiber bundle, the fiber bundle is impregnated with a resin, examples of which include the following methods (1) to (3).

(1) A method that comprises passing a fiber bundle through an impregnation bath containing an emulsion, a suspension, or a solution comprising a resin component and a solvent to impregnate the fiber bundle with the emulsion, the suspension, or the solution, and then removing the solvent.

(2) A method that comprises spraying a powder of a resin component to a fiber bundle or passing a fiber bundle through a bath containing a powder of a resin component to made the resin component powder adhere to the fiber, and then melting the powder to impregnate the fiber bundle with the resin component.

(3) A method that comprises passing a fiber bundle through a crosshead and at the same time feeding a molten resin component to the crosshead from an extruder or the like, thereby impregnating the fiber bundle with the resin component.

Preferably, the resin composition to form a foamed molded article of the present invention is produced by the above-mentioned (3), i.e., the pultrusion method using a crosshead, more preferably by a pultrusion method using a crosshead disclosed in, for example, JP 3-272830 A.

In the above-mentioned pultrusion method, the impregnation operation with a resin component may be performed either in one step or separately in two or more steps. It is also possible to blend resin composition pellets produced by the pultrusion method and resin composition pellets produced by the melt-kneading method.

When resin composition pellets are applied to injection molding, from the viewpoint of easiness with the filling into a mold cavity in injection molding and the viewpoint that a molded article with high strength can be obtained, it is preferable that the length of the resin composition pellets produced by the pultrusion method be from 2 to 50 mm. A more preferable length is from 3 to 20 mm and particularly preferably is from 5 to 15 mm. When the length of resin composition pellets is less than 2 mm, the effect to improve rigidity, heat resistance, impact strength, and a vibration-damping property may be lower in comparison with a resin component containing no surface-treated fiber (A). When the length of resin composition pellets exceeds 50 mm, their molding may become difficult.

The length of a resin composition pellet produced by a pultrusion method and the weight average fiber length of the surface-treated fiber (A) contained in the resin composition pellet are equal. That the length of a resin composition pellet and the length of the surface-treated fiber (A) contained in the resin composition pellet are equal means that the weight average fiber length of the surface-treated fiber (A) contained in the resin composition pellet is within the range of from 90 to 110% of the length of the pellet.

The weight average fiber length is measured by the method disclosed in JP 2002-5924 A with an omission of an ashing step. Specifically, the length of a fiber is measured in following procedures (ii) to (iv):

(ii) dispersing a fiber in a liquid of a weight that is 1000 or more times the weight of the fiber,

(iii) from the uniformly dispersed liquid, sampling a portion in such an amount that the fiber is contained in an amount within the range of 0.1 to 2 mg,

(iv) collecting fibers by filtration or drying from the sampled uniformly dispersed liquid and measuring the length of each of all the collected fibers.

The weight average length of the surface-treated fiber (A) in the resin composition pellet is preferably from 2 to 50 mm, more preferably from 3 to 20 mm, and even more preferably from 5 to 15 mm. In the resin composition pellets to be used for the production of the foamed molded article of the present invention, surface-treated fibers (A) are usually arranged in parallel to each other.

### [Method for Producing a Foamed Molded Article]

In producing a foamed molded article from the above-mentioned resin composition, injection foam molding method is used. The injection foam molding method is a production method including the following steps (1) to (6):

(1) a step of melting a resin composition within the cylinder of an injection molding machine to obtain a molten resin composition,

(2) a step of supplying a physical foaming agent to the cylinder of the injection molding machine and dissolving the physical foaming agent in the molten resin composition to obtain a molten foamable resin composition,

(3) a step of filling the molten foamable resin composition into a mold cavity formed by a pair of a male mold and a female mold, the volume of the molten foamable resin composition being equal to or smaller than the volume of the cavity,

(4) a step of foaming the filled foamable resin composition within the mold cavity,

(5) a step of cooling and solidifying the foamed resin composition within the mold cavity to provide a foamed molded article, and

(6) a step of opening the molds and removing the foamed molded article.

Examples of the method of melting a physical foaming agent into a molten resin composition in an injection foaming method include a method that comprises injecting a physical foaming agent in a gaseous state or in a supercritical state, described later, into a molten resin composition within a cylinder and a method that comprises injecting a physical foaming agent in a liquid state with a plunger pump or the like.

In the injection foam molding, the method of foaming the molten foamable resin composition is not particularly restricted. One example is a method in which, like the core-back molding method, a gas derived from a foaming agent is expanded by increasing the cavity volume by retreating a cavity wall, so that a molten resin composition filled in a cavity is foamed. The injected amount of the molten foamable resin composition to be injected into the cavity is preferably an amount such that the cavity is filled up with the molten foamable resin composition at a time just after the completion of the injection.

The injection method in the injection foam molding may be single screw injection, multi-screw injection, high-pressure injection, low-pressure injection, a injection method using a plunger, or the like.

The injection foam molding may be carried out in combination with such a molding method as gas-assistant molding, melt core molding, insert molding, core back molding, and two-color molding. The thermoplastic resin foamed molded article may be in any shape.

In the injection foam molding, the cylinder temperature of the injection molding machine is from 170° C. to 220° C., preferably from 180° C. to 200° C., and the cavity temperature is from 0° C. to 100° C., preferably from 5° C. to 60° C., and more preferably from 20° C. to 50° C.

The back pressure applied in the plasticization step in molding is from 1 MPa to 30 MPa, preferably from 5 MPa to 20 MPa, and even more preferably from 6 to 15 MPa. By adjusting the back pressure within such a range, it is possible to dissolve the foaming agent without allowing the molten resin composition to foam within the cylinder.

The foaming agent to be used suitably for the production of the foamed molded article of the present invention is a physical foaming agent.

Examples of the physical foaming agent include inert gas, such as nitrogen and carbon dioxide, and volatile organic compounds, such as butane and pentane. Two or more physical foaming agents may be used in combination.

Preferably, the foaming agent to be used in the present invention is an inert gas. Preferably, the inert gas is an inorganic substance that is not reactive with a resin composition to be foamed, has no fear of degrading a resin, and is in a gaseous form at normal temperature and normal pressure. Examples of the inert gas include carbon dioxide, nitrogen, argon, neon, helium, and oxygen. From the viewpoints of a low cost and safety, carbon dioxide, nitrogen, and their mixture are preferably used. Using an inert gas in a supercritical state as a foaming agent is preferable from the viewpoints of solubility and dispersibility in a resin composition.

The added amount of the foaming agent is from 0.3 parts by mass to 10 parts by mass, preferably from 0.6 parts by mass to 5 parts by mass, and more preferably from 0.6 parts by mass to 4 parts by mass relative to 100 parts by mass of the above-mentioned resin composition.

To the foaming agent may be added a chemical foaming agent, and chemical foaming agents that can be applied include inorganic chemical foaming agents and organic chemical foaming agents.

Examples of the inorganic chemical foaming agents include hydrogen carbonates such as sodium hydrogen carbonate, and ammonium carbonate.

Examples of the organic chemical foaming agents include polycarboxylic acids, azo compounds, sulfonehydrazide compounds, nitroso compounds, p-toluenesulfonyl semicarbazide, and isocyanate compounds.

Examples of the polycarboxylic acids include citric acid, oxalic acid, fumaric acid, and phthalic acid.

The expansion ratio of a foamed molded article according to the present invention, which is a value obtained by dividing the density of the resin composition by the density of the foamed molded article, is preferably from 1.3 times to 5 times and more preferably from 1.5 times to 3.5 times.

The weight average fiber length of the surface-treated fiber (A) contained in a foamed molded article of the present invention is from 2 to 50 mm, preferably from 5 to 20 mm, and more preferably from 5 to 12 mm.

### Examples

The present invention is hereafter further explained on the basis of Examples, but the invention is not limited to the Examples.

In Examples and Comparative Examples were used the resins given below.

### (1) Surface-Treated Fiber (A-1)

A polyester fiber (A-1) having been surface-treated with a polyurethane resin was produced. After solid phase polymerization using chips of polyethylene-2,6-naphthalene dicarboxylate with an intrinsic viscosity of 0.62 dl/g, a base fiber with a fineness of 1,100 dtex/250f was obtained by a melt spinning drawing method. The single yarn fineness was 4 dtex and the single yarn diameter was 20 μm. The intrinsic viscosity of the material forming this base fiber was 0.90 dl/g. This base fiber had a tensile strength of 7.8 cN/dtex, a tensile modulus of 170 cN/dtex, a dry heat shrinkage at 180° C. of 6.2%, and it was high in modulus and superior in dimensional stability.

This base fiber was subjected to dip treatment using as a sizing agent, a polyurethane resin treating solution that had carboxylate as a hydrophilic component in the molecule and that was capable of emulsifying itself with stability in the water. The solvent of this treating solution was water.

The polyurethane resin concentration of this treating solution was 8% by weight and the dispersed particle diameter of the polyurethane resin emulsion was 61 nm. Regarding the physical properties of a coating film obtained by evaporating water from the polyurethane resin treating solution, the tensile strength was 35 MPa, the elongation was 30%, the glass transition temperature was 61° C., and the softening and melting temperature was 113° C.

A surface-treated fiber (A-1) having been surface-treated with a polyurethane resin was obtained by subjecting the base fiber to the dip treatment, then drying the base fiber with a non-contact heater at 150° C. for 15 seconds and subsequently applying heat treatment at 180° C. for 15 seconds. The adhering amount of the polyurethane resin relative to 100 parts by weight of the base fiber was 3.0% by weight.

### (2) Surface-Treated Fiber (A-2)

After solid phase polymerization using chips of polyethylene-2,6-naphthalene dicarboxylate with an intrinsic viscosity of 0.62 dl/g, a base fiber with a fineness of 1,670 dtex/144f was obtained by a melt spinning drawing method. The single yarn fineness was 13 dtex and the single yarn diameter was 35 μm. The intrinsic viscosity of the material forming this base fiber was 0.90 dl/g. This base fiber had a tensile strength of 7.9 cN/dtex, a tensile modulus of 170 cN/dtex, a dry heat shrinkage at 180° C. of 5.9%, and it was high in modulus and superior in dimensional stability.

This base fiber was subjected to dip treatment using as a sizing agent, a polyurethane resin treating solution that had carboxylate as a hydrophilic component in the molecule and that was capable of emulsifying itself with stability in the water. The solvent of this treating solution was water.

The polyurethane resin concentration of this treating solution was 8% by weight and the water dispersed particle diameter of the polyurethane resin emulsion was 61 nm. Regarding the physical properties of a film obtained by evaporating water from the polyurethane resin treating solution, the tensile strength was 35 MPa, the elongation was 30%, the glass transition temperature was 61° C., and the softening and melting temperature was 113° C.

A surface-treated fiber (A-2) having been surface-treated with a polyurethane resin was obtained by subjecting the base fiber to the dip treatment, then drying the base fiber with a non-contact heater at 150° C. for 15 seconds and subsequently applying heat treatment at 180° C. for 15 seconds. The adhering amount of the polyurethane resin relative to 100 parts by weight of the base fiber was 3.0% by weight.

### (3) Surface-Treated Fiber (A-3)

A surface-treated fiber (A-3), which was a polyester fiber having been surface-treated with an acid-modified polyolefin resin, was produced.

After solid phase polymerization using chips of polyethylene-2,6-naphthalene dicarboxylate with an intrinsic viscosity of 0.62 dl/g, a base fiber with a fineness of 1,670 dtex/144f was obtained by a melt spinning drawing method. The single yarn fineness was 13 dtex and the single yarn diameter was 35 μm. The intrinsic viscosity of the material forming this base fiber was 0.90 dl/g. This base fiber had a tensile strength of 7.9 cN/dtex, a tensile modulus of 170 cN/dtex, a dry heat shrinkage at 180° C. of 5.9%, and it was high in modulus and superior in dimensional stability.

A surface-treated fiber (A-3) was obtained by providing the base fiber with a sizing agent, which was a mixture of 26 parts of a polypropylene-maleic anhydride graft polymer, 52 parts of polyglycerol polyglycidyl ether, and 22 parts of ethylene oxide (EO) 7-mol adduct of laurylamine, so that the adhering amount after drying would be 3.0% by weight relative to the weight of the base fiber, then applying heat treatment at 150° C. for 5 seconds with a non-contact heater.

### (4) Surface-Untreated Fiber (E-1)

After solid phase polymerization using chips of polyethylene-2,6-naphthalene dicarboxylate with an intrinsic viscosity of 0.62 dl/g, a polyester fiber (E-1) with a fineness of 1,100 dtex/250f was obtained by a melt spinning drawing method. The single yarn fineness was 4 dtex and the single yarn diameter was 20 μm. The intrinsic viscosity of the material forming this fiber was 0.90 dl/g. This fiber had a tensile strength of 7.8 cN/dtex, a tensile modulus of 170 cN/dtex, a dry heat shrinkage at 180° C. of 6.2%, and it was high in modulus and superior in dimensional stability.

### (3) Modified Polyolefin Resin (B)

A maleic anhydride-modified polypropylene resin prepared in accordance with the method disclosed in Example 1 of JP 2004-197068A, to which Example 1 disclosed in US 2004/0002569 corresponds.

MFR: 60 g/10 min

Maleic anhydride graft amount: 0.6% by weight

### (4) Polyolefin Resin (C)

A propylene homopolymer available from Sumitomo Chemical Co., Ltd. under the commercial name “U501E1”

MFR: 120 g/10 min

### (5) Glass Fiber-Reinforced Polypropylene Resin (D)

A glass fiber-reinforced polypropylene resin pellet with a length of 9 mm was produced by the method disclosed in JP 3-121146 A with a composition composed of 2.5% by weight of maleic anhydride-modified polypropylene resin (MFR: 60 g/10 minutes, maleic anhydride graft amount: 0.6% by weight), 50% by weight of glass fiber (fiber diameter: 17 μm), 47% by weight of a propylene homopolymer (MFR: 100 g/10 minutes), 0.3% by weight of a sulfur-containing antioxidant (commercial name: SUMILIZER TPM, produced by Sumitomo Chemical Co., Ltd.), 0.1% by weight of a phenolic antioxidant (commercial name: IRGANOX 1010, produced by Ciba Japan), and 0.1% by weight of a phenolic antioxidant (commercial name: IRGANOX 1330, produced by Ciba Japan). The impregnation temperature was 270° C. and the take-off speed was 13 m/second.

### [Method of Evaluation]

### (1) Melt Flow Rate (MFR)

Measurement was conducted under conditions including a temperature of 230° C. and a load of 21.2 N in accordance with JIS K7210.

### (2) Density

The density of a foamed molded article was determined by measuring the specific gravity of the foamed molded article with a specific gravimeter (electronic specific gravimeter EW-200SG, available from Mirage Trading Co., Ltd.,) and considering the density of pure water as 1.0 g/cm³. The density of a resin composition was also measured in the same way.

### (3) Expansion Ratio

The expansion ratio of a foamed molded article was determined by dividing the density of a resin composition by the density of the foamed molded article, wherein the density of the resin composition and the density of the foamed molded article were determined by the above-described method of density measurement.

### (4) Impact Value

Regarding the impact value of a foamed molded article, a sample fixed with a ring having an inner diameter of 3 inches was punched through with a HIGH RATE IMPACT TESTER (manufactured by Reometrics. Inc) at a measurement temperature of 23° C., a dart diameter of ½ inches, and a speed of 5 m/sec, so that a waveform of displacement versus load was measured. Then, an energy value needed for the punching was calculated and this was used as an “impact value.”

### Example 1

A foamed molded article was produced by the following method.

According to the method disclosed in JP 3-121146 A, fiber-reinforced pellets with a pellet length of 11 mm were produced in the composition provided in Table 1. Injection foam molding was carried out by using the resulting pellets and using an injection molding machine ES2550/400 HL-MuCell (clamping force=400 tons) manufactured by ENGEL and a pair of male and female molds with a box-shaped cavity having dimensions of 290 mm×370 mm, a height of 45 mm and a thickness of 1.5 mm (gate structure: valve gate, located at the central part of a molded article). Nitrogen gas, which is a foaming agent, was fed at a pressure of 9 MPa into the cylinder of the aforementioned injection molding machine (the injected amount of the foaming agent: 0.8 parts by weight relative to 100 parts by weight of the resin composition to be injected). A foamable resin composition was injected into the molds at a molding temperature of 200° C. and a mold temperature of 50° C. so that the mold would be fully filled. After a lapse of four seconds from the completion of the injection, the foamable resin composition was foamed by increasing the volume of the cavity by retreating the mold cavity wall of one mold by 2 mm, and then the foamed resin composition was cooled to solidify, so that a foamed molded article was obtained. The resulting foamed molded article was evaluated and the results are shown in Table 1.

### Example 2

A foamed molded article was produced and evaluated in the same procedures as those used in Example 1 except that the composition was that provided in the column of Example 2 in Table 1. The results are shown in Table 1.

### Example 3

A foamed molded article was produced and evaluated in the same procedures as those used in Example 1 except that the composition was that provided in the column of Example 3 in Table 1. The results are shown in Table 1.

### Comparative Example 1

A foamed molded article was produced and evaluated in the same procedures as those used in Example 1 except that the molten resin was foamed without increasing the volume of the cavity after the completion of the injection. The results are shown in Table 1.

### Comparative Example 2

A foamed molded article was produced and evaluated in the same procedures as those used in Example 2 except that the molten resin was foamed without increasing the volume of the cavity after the completion of the injection. The results are shown in Table 1.

### Comparative Example 3

A foamed molded article was produced and evaluated in the same procedures as those used in Example 3 except that the molten resin was foamed without increasing the volume of the cavity after the completion of the injection. The results are shown in Table 1.

### Comparative Example 4

A foamed molded article was produced and evaluated in the same procedures as those used in Example 4 except that the composition was that provided in the column of Comparative Example 4 in Table 1. The results are shown in Table 1.

### Comparative Example 5

A foamed molded article was produced and evaluated in the same procedures as those used in Example 1 except that the composition was that provided in the column of Comparative Example 5 in Table 1. The results are shown in Table 1.

### Comparative Example 6

A foamed molded article was produced and evaluated in the same procedures as those used in Example 4 except that the composition was that provided in the column of Comparative Example 6 in Table 1. The results were shown in Table 1.

### INDUSTRIAL APPLICABILITY

According to the present invention, it becomes possible to provide a foamed molded article superior in impact resistance.

TABLE 1

| | | | Examples | | | Comparative Example | | | | | |
|---|---|---|---|---|---|---|---|---|---|---|---|
| | | | 1 | 2 | 3 | 1 | 2 | 3 | 4 | 5 | 6 |
| A-1 | | | 21 | | | 21 | | | | | |
| A-2 | | | | 20 | | | 20 | | | | |
| A-3 | | | | | 20 | | | 20 | | | |
| E-1 | | | | | | | | | 20 | | |
| B | | | 3 | 2 | 4 | 3 | 2 | 4 | 4 | | |
| C | | | 76 | 78 | 76 | 76 | 78 | 76 | 76 | | |
| D | | | | | | | | | | 100 | 100 |
| Fiber diameter | | μm | 20 | 33 | 33 | 20 | 33 | 33 | 20 | 17 | 17 |
| Pellet length | | mm | 11 | 11 | 11 | 11 | 11 | 11 | 11 | 9 | 9 |
| Material density | | g/cm_{³} | 0.97 | 0.97 | 0.98 | 0.97 | 0.97 | 0.98 | 0.98 | 1.11 | 1.11 |
| Evaluation results | | | | | | | | | | | |
| of molded article | | | | | | | | | | | |
| Foamed | Thickness | mm | 3.97 | 3.925 | 3.91 | 1.53 | 1.54 | 1.55 | 3.81 | 3.69 | 1.53 |
| molded | of molded | | | | | | | | | | |
| article | article | | | | | | | | | | |
| | Density | g/cm_{³} | 0.36 | 0.36 | 0.35 | 0.9 | 0.83 | 0.82 | 0.35 | 0.43 | 1.04 |
| | of foamed | | | | | | | | | | |
| | molded | | | | | | | | | | |
| | article | | | | | | | | | | |
| | Expansion | | 2.70 | 2.70 | 2.79 | 1.08 | 1.17 | 1.19 | 2.79 | 2.58 | 1.07 |
| | ratio | | | | | | | | | | |
| | Impact | J | 4.7 | 4.8 | 5.2 | 3.5 | 3.7 | 4.3 | 3.8 | 2.2 | 3.5 |
| | value | | | | | | | | | | |

1. A foamed molded article formed of a resin composition comprising a reinforcing fiber and a resin component, wherein the reinforcing fiber comprises a surface-treated fiber (A) comprising a base fiber (A-I) composed of a polyalkylene terephthalate and/or a polyalkylene naphthalene dicarboxylate and from 0.1 to 10 parts by weight, relative to 100 parts by weight of the base fiber (A-I), of a sizing agent (A-II) adhering to the surface of the base fiber (A-1), and the resin component comprises a modified polyolefin resin (B) which is a polyolefin resin modified with an unsaturated carboxylic acid and/or an unsaturated carboxylic acid derivative, wherein the foamed molded article has an expansion ratio is 1.3 to 5.

2. The foamed molded article according to claim 1, wherein the foamed molded article contains from 1 to 70% by weight of the surface-treated fiber (A) and from 30 to 99% by weight of the resin component, wherein the resin component contains from 0.5 to 40% by weight of the modified polyolefin resin (B) and from 60 to 99.5% by weight of a polyolefin resin (C).

3. The foamed molded article according to claim 1, wherein the sizing agent (A-II) contains at least one resin selected from the group consisting of polyolefin resins and polyurethane resins.

4. The foamed molded article according to claim 1, wherein the sizing agent (A-II) contains at least one polyolefin resin and an epoxy compound which has two or more epoxy groups in one molecule.

5. The foamed molded article according to claim 1, wherein the sizing agent (A-II) contains at least one polyolefin resin and an ethylene oxide adduct of an aliphatic amine compound and/or a propylene oxide adduct of an aliphatic amine compound.

6. The foamed molded article according to claim 3, wherein each polyolefin resin contained in the sizing agent (A-II) is a resin modified with an unsaturated carboxylic acid and/or an unsaturated carboxylic acid derivative.

7. The foamed molded article according to claim 4, wherein the surface-treated fiber (A) comprises 100 parts by weight of the fiber (A-I) and the sizing agent (A-II) comprising from 0.1 to 2 parts by weight of a polyolefin resin modified with an unsaturated carboxylic acid and/or an unsaturated carboxylic acid derivative, and from 0.1 to 1 part by weight of an epoxy compound having two or more epoxy groups in one molecule.

8. The foamed molded article according to claim 1, wherein the weight average fiber length of the surface-treated fiber (A) contained in the foamed molded article is from 2 to 50 mm.

9. A method for producing a foamed molded article, the method comprising the following steps (1) to (6):
(1) a step of melting a resin composition containing a reinforcing fiber and a resin component within a cylinder of an injection molding machine to obtain a molten resin composition, wherein the reinforcing fiber comprises a surface-treated fiber (A) comprising a base fiber (A-I) composed of a polyalkylene terephthalate and/or a polyalkylene naphthalene dicarboxylate and from 0.1 to 10 parts by weight, relative to 100 parts by weight of the base fiber (A-I), of a sizing agent (A-II) adhering to the surface of the base fiber (A-1), and the resin component comprises a modified polyolefin resin (B) which is a polyolefin resin modified with an unsaturated carboxylic acid and/or an unsaturated carboxylic acid derivative,
(2) a step of supplying a physical foaming agent to the cylinder of the injection molding machine and dissolving the physical foaming agent in the molten resin composition to obtain a molten foamable resin composition,
(3) a step of injecting the molten foamable resin composition into a mold cavity formed by a pair of a male mold and a female mold, the volume of the molten foamable resin composition being equal to or smaller than the volume of the cavity,
(4) a step of foaming, within the mold cavity, the foamable resin composition fed into the molds,
(5) a step of forming a foamed molded article by cooling and solidifying, in the mold cavity, the resin composition foamed in the mold cavity, and
(6) a step of opening the molds and removing the foamed molded article.
